(19) United States
(12) Patent Application Publication
(10) Pub. No.: US 2017/0128320 A1
(43) Pub. Date: May 11, 2017

(54) MASSAGE CHAIR

(71) Applicant: Chi-Hsuan Chen, Changhua (TW)

(72) Inventor: Chi-Hsuan Chen, Changhua (TW)

(73) Assignee: HSIN HAO HEALTH MATERIALS CO., LTD., CHANGHUA (TW)

(21) Appl. No.: 14/937,695

(22) Filed: Nov. 10, 2015

(51) Int. Cl. A61H 23/02; A61H 15/00

(52) U.S. Cl. CPC A61H 23/02; A61H 15/0078

(57) ABSTRACT

A massage chair may include a base unit, a seat unit, a reciprocating unit and a massage unit. The base unit comprises two frames formed at each of two lateral sides of the base unit. Each of two lateral sides of the seat unit has a rear guiding rail and a lower guiding rail, which are connected to each other with a defined angle. A rear frame connected with two outer laterals of the rear guiding rails protrudes from a rear portion of the seat unit. The reciprocating unit comprises a base secured under the rear frame, and a motor is secured on the base. Moreover, a threaded rod vertically protrudes from a top portion of the base, and is driven by the motor to spin relative to a surface of the base.

### FIELD OF THE INVENTION

The present invention relates to a massage chair, and more particularly to a massage chair with a massaging range that can extend to the hip of a human body.

### BACKGROUND OF THE INVENTION

With the rapid economic development, people nowadays pay much attention on the quality of life. Nonetheless, the requirement for better life leads people to suffer more pressures at life, family and work, resulting in causing the physical and mental burdens on people. Thus, there is a need to find a way to relieve pressure. The most common way for people to relieve pressure is looking for a massage therapist. However, this way has its limitation that people have to cooperate with the massage therapist on time and place, and it is also an additional cost for a long time.

However, the conventional massage chair is disadvantageous because: generally, when a human on the seat of massage chair, a reciprocating unit of the conventional massage chair can only drive two swing arms thereof to move up and down on a back portion of massage chair, and cannot reach the hip part of a human body, leading to lowering the massage effect. Therefore, there remains a need for a new and improved design for a massage chair to overcome the problems presented above.

### SUMMARY OF THE INVENTION

The present invention provides a massage chair, which comprises a base unit, a seat unit, a reciprocating unit and a massage unit. A side having a chair back is defined as a rear side of the massage chair, and an opposite side of the rear side is defined as a front side of the massage chair. The base unit comprises two frames formed at each of two lateral sides of the base unit, and a plurality of connecting rods are formed between the two frames. A support frame mounted on two of the connecting rods at a lower portion of the base unit is upwardly inclined toward the front side of the massage chair. A power unit and a blocking piece are mounted on the support frame, and the blocking piece driven by the power unit is able to move on the support frame. Each of the two frames has a first guiding rail and a second guiding rail formed at an upper front side thereof and an upper rear side thereof respectively. The first guiding rails are downwardly inclined toward the rear side of the massage chair, and the second guiding rails are downwardly inclined toward the front side of the massage chair. Each of two lateral sides of the seat unit has a rear guiding rail and a lower guiding rail, which are connected to each other with a defined angle. A lower frame connected with two outer laterals of the lower guiding rails is configured to allow the seat unit to locate on the frames. A rear frame connected with two outer laterals of the rear guiding rails protrudes from a rear portion of the seat unit. A bottom portion of the lower frame connected to a bottom frame and two wheel bases, and each of two sides of the bottom frame has a first guiding wheel, and also each of the two wheel bases has the first guiding wheel. When the seat unit is connected to the base unit, the two first guiding wheels on the bottom frame are coupled on the two first guiding rails respectively, and the two first guiding wheels on the wheel bases are coupled on the two second guiding rails respectively. As a result, each of the first guiding wheels is able to slide on the first guiding rails and the second guiding rails respectively. Also, when the seat unit is connected to the base unit, the bottom frame is borne against the blocking piece of the base unit. The reciprocating unit comprises a base secured under the rear frame, and a motor is secured on the base. Moreover, a threaded rod vertically protrudes from a top portion of the base, and is driven by the motor to spin relative to a surface of the base. An elevating piece coupled on the threaded rod is configured to pivotally connect to the massage unit. Each of two lateral sides of the massage unit has two second guiding wheels. When the massage unit is connected to the reciprocating unit, the second guiding wheels on the two lateral sides of the massage unit are respectively coupled on the rear guiding rails of the seat unit. As a result, the second guiding wheels are able to slide on the rear guiding rail, and the massage unit connected with the elevating piece is driven by the threaded rod to achieve reciprocating motion on the seat unit. Also, since the two rear guiding rails are connected to the two lower guiding rails respectively, the second guiding wheels of massage unit are able to slide from both lower ends of the rear guiding rails to the lower guiding rails, resulting in achieving the hip massage.

Comparing with conventional massage chair, the present invention is advantageous because: (i) since the two rear guiding rails are connected to the two lower guiding rail respectively, the second guiding wheels of massage unit are able to slide from the two lower ends of the rear guiding rails to the lower guiding rails, resulting in achieving the hip massage; and (ii) because of the blocking piece borne against the bottom frame, and the support frame, the first guiding rail and the second guiding rail tilted with an angle, when the blocking piece is driven by the power unit to slantingly move toward the front side of the massage chair, the bottom frame pushed by the blocking piece is gradually shifted upward with an angle, resulting in the seat unit being reclined. Furthermore, since an angle between the rear guiding rail and the lower guiding rail is fixed, the massage unit is still able to move between the rear guiding rail and the lower guiding rail to achieve the hip massage after the seat unit is reclined.

### BRIEF DESCRIPTION OF THE DRAWINGS

FIG. 1 is a three-dimensional assembly of the massage chair in present invention.

FIG. 2 is a three-dimensional, exploded view of the massage chair in present invention.

FIG. 3 is a plane view of the massage chair in present invention.

FIG. 4 is a plane view from another angle of the massage chair in present invention.

FIG. 5 is a three-dimensional view of the massage chair in present invention, when the massage chair provides the hip massage.

FIG. 6 is a plane view of the massage chair in present invention, when the massage chair provides the hip massage.

FIG. 7 is a schematic view of the massage chair in present invention when a seat unit is reclined.

FIG. 8 is a schematic view of the massage chair in present invention keeping a function of the hip massage when a seat unit is reclined.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

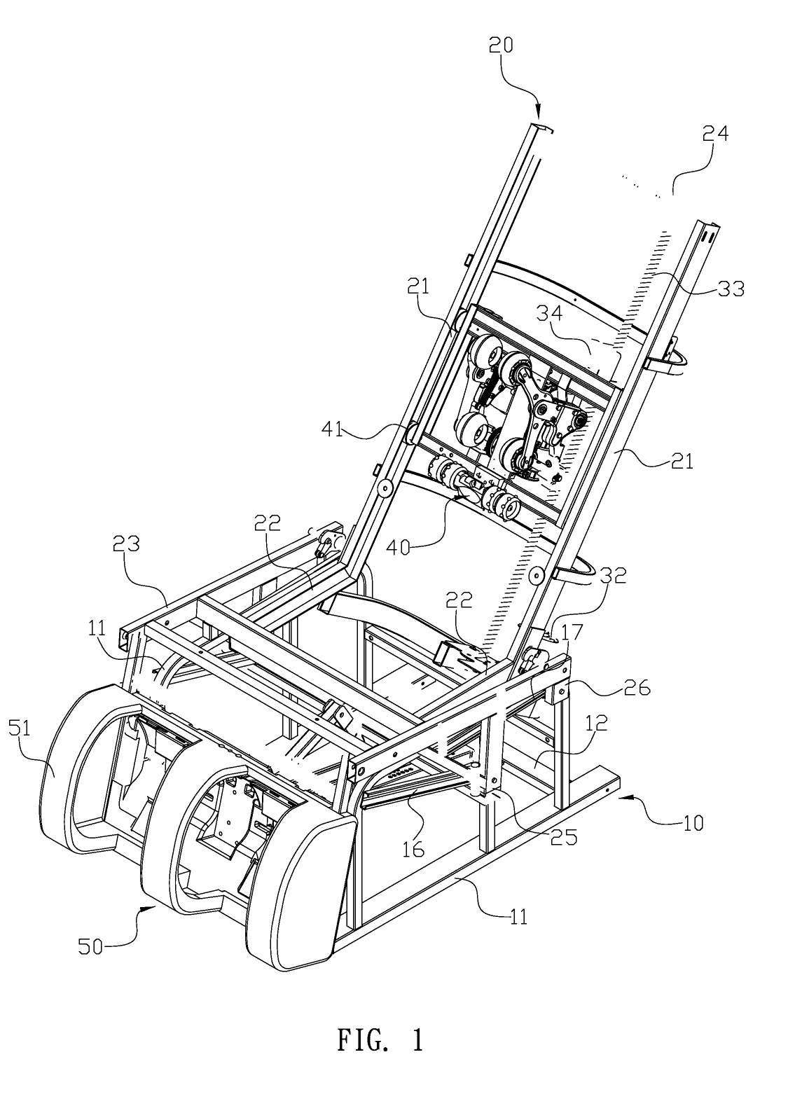

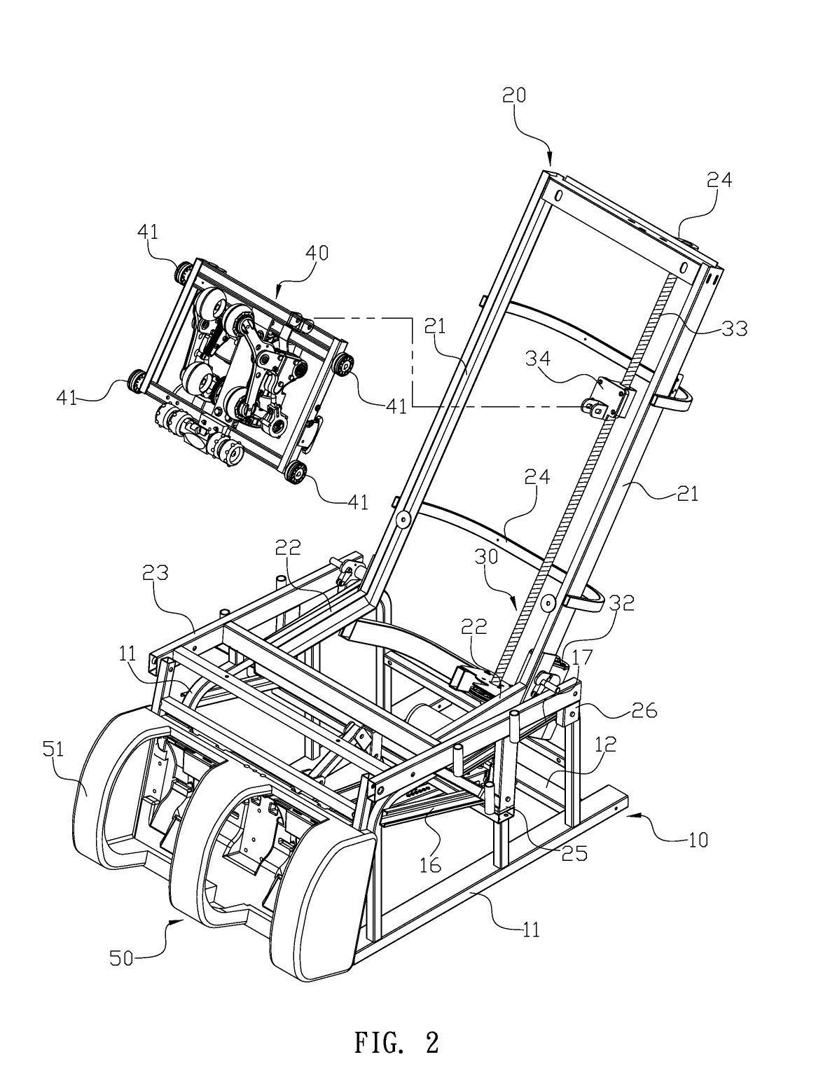

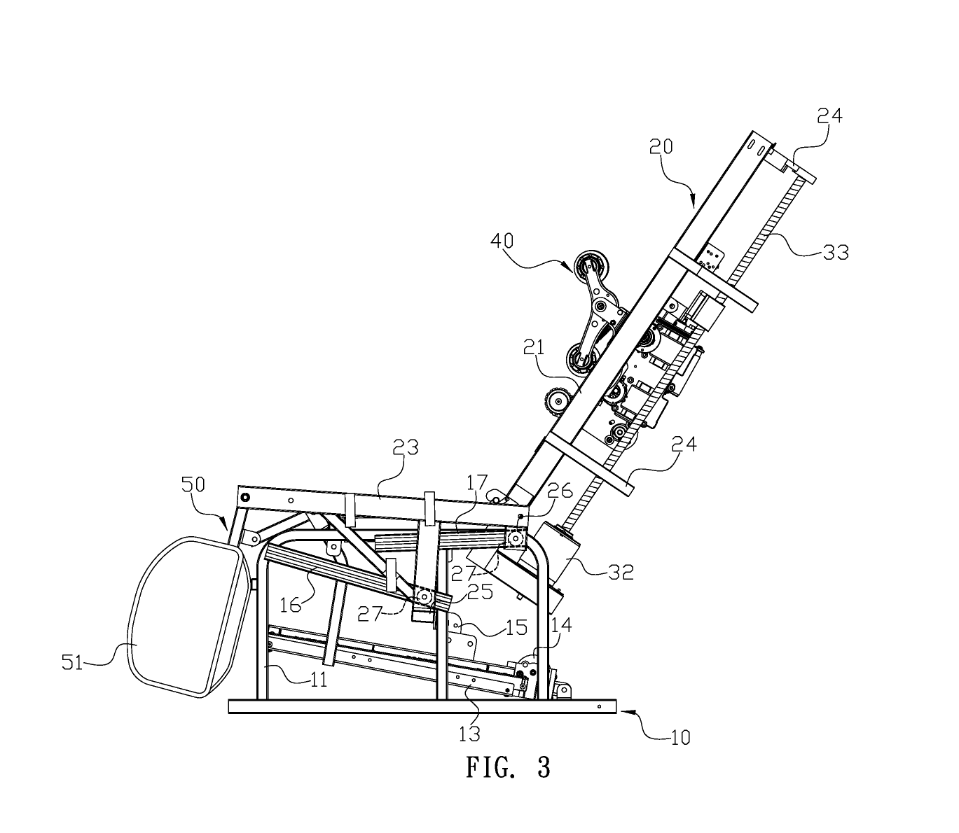

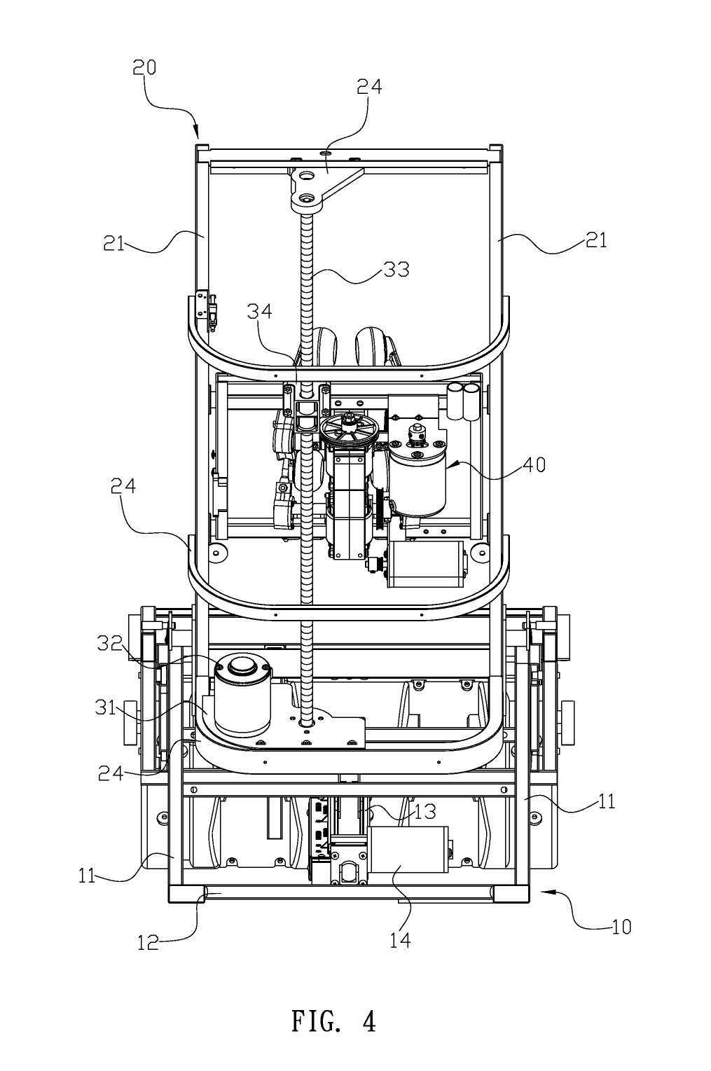

Referring to FIGS. 1 to 4, the present invention provides a massage chair, which comprises a base unit (10), a seat unit (20), a reciprocating unit (30) and a massage unit (40). A side having a chair back is defined as a rear side of the massage chair, and an opposite side of the rear side is defined as a front side of the massage chair. The base unit (10) comprises two frames (11) formed at each of two lateral sides of the base unit (10), and a plurality of connecting rods (12) are formed between the two frames (11). A support frame (13) mounted on two of the connecting rods (12) at a lower portion of the base unit (10) is upwardly inclined toward the front side of the massage chair. A power unit (14) and a blocking piece (15) are mounted on the support frame (13), and the blocking piece (15) driven by the power unit (14) is able to move on the support frame (13). Each of the two frames (11) has a first guiding rail (16) and a second guiding rail (17) formed at an upper front side thereof and an upper rear side thereof respectively. The first guiding rails (16) are downwardly inclined toward the rear side of the massage chair, and the second guiding rails (17) are downwardly inclined toward the front side of the massage chair. Each of two lateral sides of the seat unit (20) has a rear guiding rail (21) and a lower guiding rail (22), which are connected to each other with a defined angle. A lower frame (23) connected with two outer laterals of the lower guiding rails (22) is configured to allow the seat unit (20) to locate on the frames (11). A rear frame (24) connected with two outer laterals of the rear guiding rails (21) protrudes from a rear portion of the seat unit (20). A bottom portion of the lower frame (23) connected to a bottom frame (25) and two wheel bases (26), and each of two sides of the bottom frame (25) has a first guiding wheel (27), and also each of the two wheel bases (26) has the first guiding wheel (27). When the seat unit (20) is connected to the base unit (10), the two first guiding wheels (27) on the bottom frame (25) are coupled on the two first guiding rails (16) respectively, and the two first guiding wheels (27) on the wheel bases (26) are coupled on the two second guiding rails (17) respectively. As a result, each of the first guiding wheels (27) is able to slide on the first guiding rails (16) and the second guiding rails (17) respectively. Also, when the seat unit (20) is connected to the base unit (10), the bottom frame (25) is borne against the blocking piece (15) of the base unit (10). The reciprocating unit (30) comprises a base (31) secured under the rear frame (24), and a motor (32) is secured on the base (31). Moreover, a threaded rod (33) vertically protrudes from a top portion of the base (31), and is driven by the motor (32) to spin relative to a surface of the base (31). An elevating piece (34) coupled on the threaded rod (33) is configured to pivotally connect to the massage unit (40). Each of two lateral sides of the massage unit (40) has two second guiding wheels (41). When the massage unit (40) is connected to the reciprocating unit (30), the second guiding wheels (41) on the two lateral sides of the massage unit (40) are respectively coupled on the rear guiding rails (21) of the seat unit (20). As a result, the second guiding wheels (41) are able to slide on the rear guiding rail (21), and the massage unit (40) connected with the elevating piece (34) is driven by the threaded rod (33) to achieve reciprocating motion on the seat unit (20). Also, since the two rear guiding rails (21) are connected to the two lower guiding rails (22) respectively, the second guiding wheels (41) of massage unit (40) are able to slide from both lower ends of the rear guiding rails (21) to the lower guiding rails (22), resulting in achieving the hip massage.

In one embodiment, the threaded rod (33) is connected to the motor (32) through a belt to achieve power transmission.

In another embodiment, a front portion of the lower frame (23) of the seat unit (20) is pivotally connected to a footrest (50). The footrest (50) comprises a roller shell (51), and at least a massaging roller is accommodated inside of the roller shell (51) to achieve the foot massage.

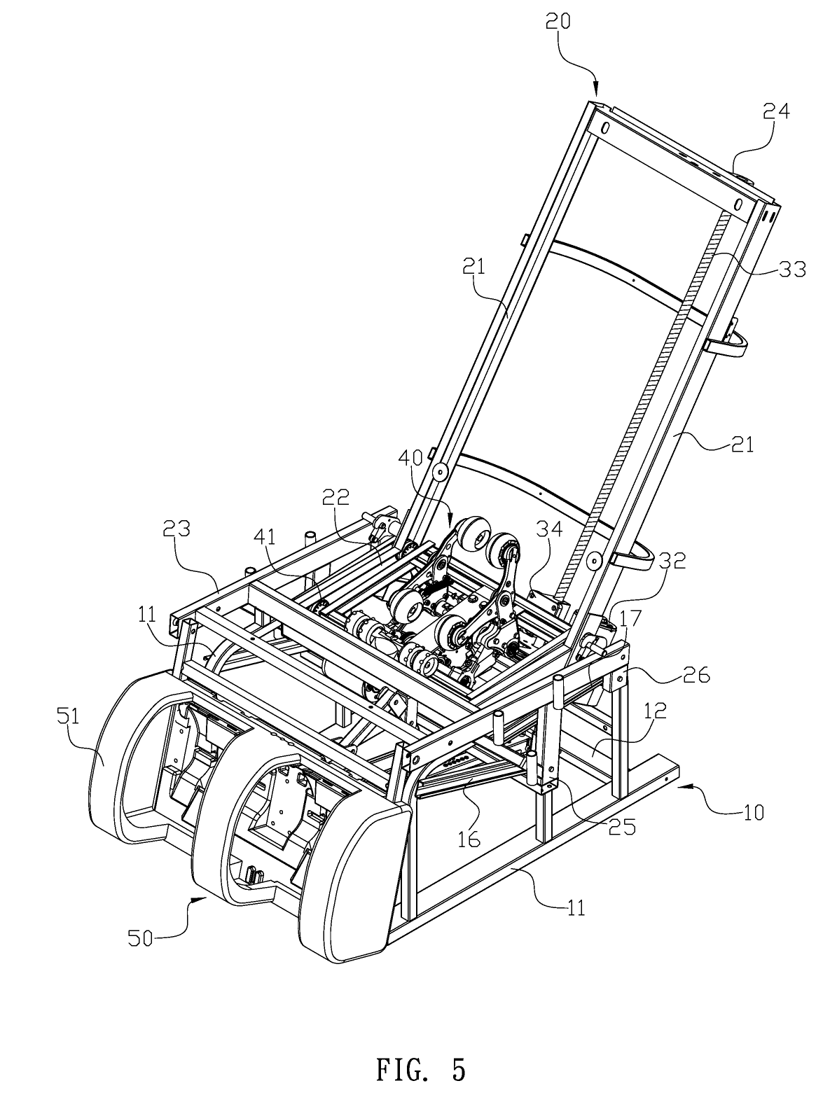

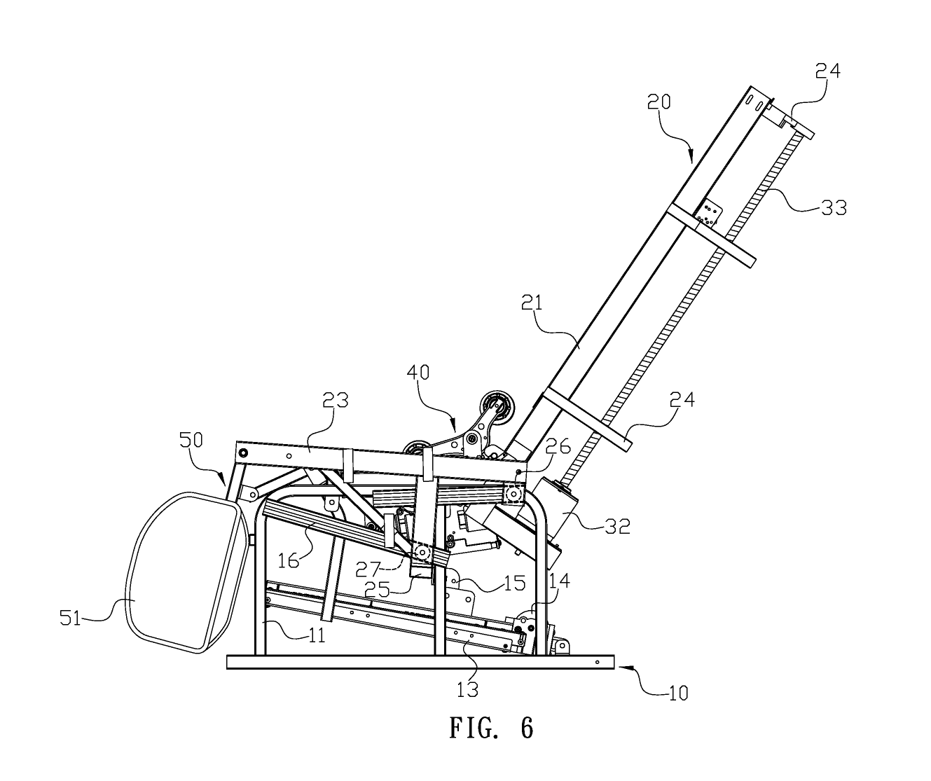

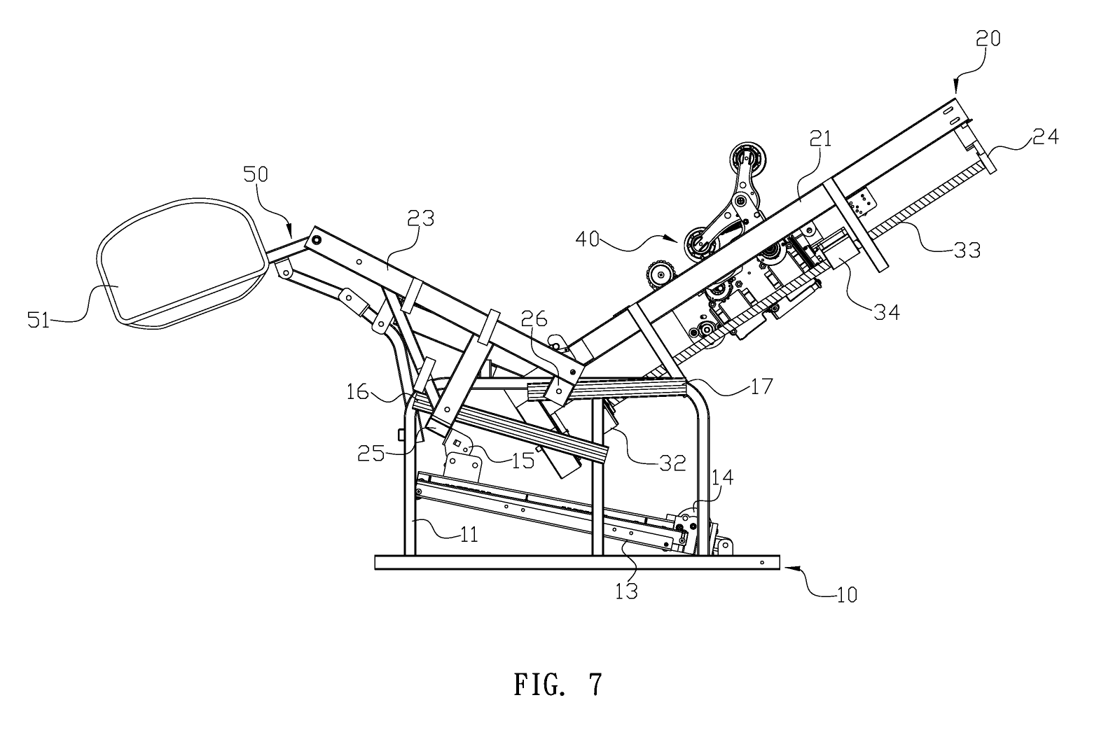

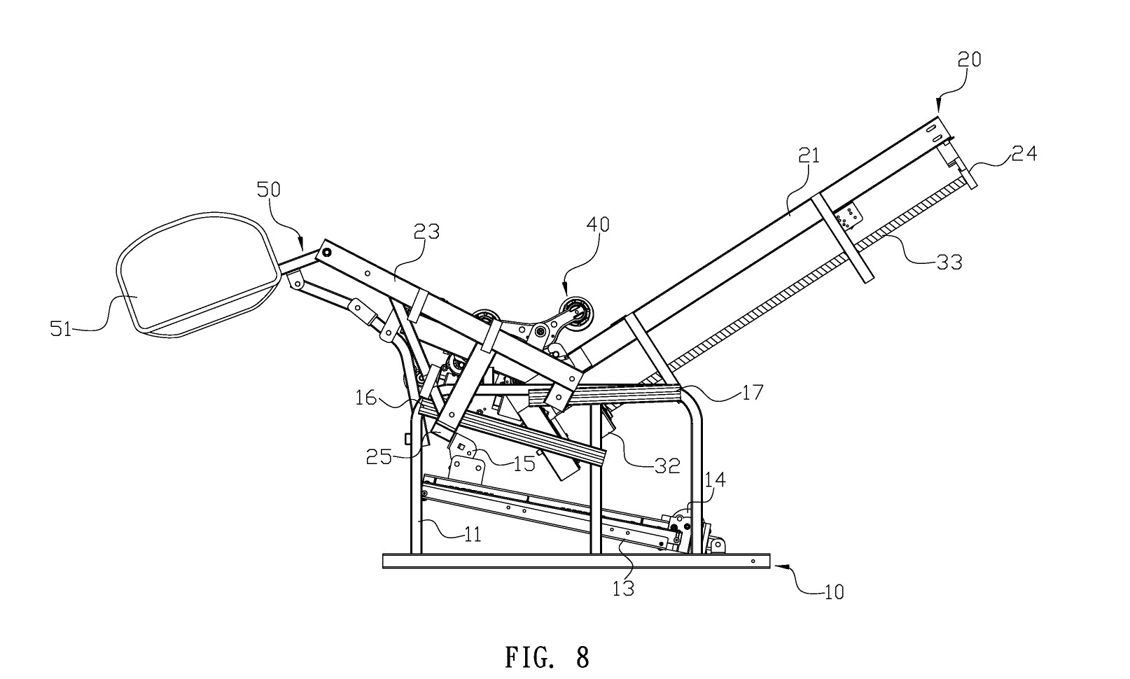

In actual application, the threaded rod (33) driven by the motor (32) allows the elevating piece (34) with the massage unit (40) to achieve the reciprocating motion on the seat unit (20). Also, since the two rear guiding rails (21) are connected to the two lower guiding rail (22) respectively, the second guiding wheels (41) of massage unit (40) are able to slide from the two lower ends of the rear guiding rails (21) to the lower guiding rails (22) (as shown in FIGS. 5 and 6), resulting in achieving the hip massage. Moreover, because of the blocking piece (15) borne against the bottom frame (25), and the support frame (13), the first guiding rail (16) and the second guiding rail (17) tilted with an angle, when the blocking piece (15) is driven by the power unit (14) to slantingly move toward the front side of the massage chair, the bottom frame (25) pushed by the blocking piece (15) is gradually shifted upward with an angle, resulting in the seat unit (20) being reclined (as shown in FIG. 7). Furthermore, since an angle between the rear guiding rail (21) and the lower guiding rail (22) is fixed, the massage unit (40) is still able to move between the rear guiding rail (21) and the lower guiding rail (22) to achieve the hip massage after the seat unit (20) is reclined (as shown in FIG. 8).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A massage chair comprising, a base unit, a seat unit, a reciprocating unit and a massage unit, and a side which has a chair back defined as a rear side of the massage chair, and an opposite side of the rear side defined as a front side of the massage chair,
wherein the base unit comprises two frames formed at each of two lateral sides of the base unit, and a plurality of connecting rods are formed between the two frames, and a support frame mounted on two of the connecting rods at a lower portion of the base unit, and a power unit and a blocking piece are mounted on the support frame, and the blocking piece driven by the power unit is able to move on the support frame, wherein each of the two frames has a first guiding rail and a second guiding rail formed at an upper front side thereof and an upper rear side thereof respectively;
wherein each of two lateral sides of the seat unit has a rear guiding rail and a lower guiding rail, which are connected to each other with a defined angle, and a lower frame connected with two outer laterals of the lower guiding rails is configured to allow the seat unit to locate on the frames, and a rear frame connected with two outer laterals of the rear guiding rails protrudes from a rear portion of the seat unit, and a bottom portion of the lower frame connected to a bottom frame and two wheel bases, and each of two sides of the bottom frame has a first guiding wheel, and also each of the two wheel bases has the first guiding wheel, wherein when the seat unit is connected to the base unit, the two first guiding wheels on the bottom frame are coupled on the two first guiding rails respectively, and the two first guiding wheels on the wheel bases are coupled on the two second guiding rails respectively, as a result, each of the first guiding wheels is able to slide on the first guiding rails and the second guiding rails respectively, wherein when the seat unit is connected to the base unit, the bottom frame is borne against the blocking piece of the base unit; and
wherein the reciprocating unit comprises a base secured under the rear frame, and a motor is secured on the base, and a threaded rod vertically protrudes from a top portion of the base, and is driven by the motor to spin relative to a surface of the base, and an elevating piece coupled on the threaded rod is configured to pivotally connect to the massage unit, each of two lateral sides of the massage unit has two second guiding wheels, wherein when the massage unit is connected to the reciprocating unit, the second guiding wheels on the two lateral sides of the massage unit are respectively coupled on the rear guiding rail of the seat unit, wherein since the two rear guiding rails are connected to the two lower guiding rails respectively, the second guiding wheels of massage unit are able to slide from both lower ends of the rear guiding rails to the lower guiding rails, resulting in achieving the hip massage.

2. The massage chair of claim 1, wherein the support frame mounted on the two of the connecting rods at a lower portion of the base unit is upwardly inclined toward the front side of the massage chair.

3. The massage chair of claim 1, wherein the first guiding rails are downwardly inclined toward the rear side of the massage chair, and the second guiding rails are downwardly inclined toward the front side of the massage chair.

4. The massage chair of claim 1, wherein the threaded rod is connected to the motor through a belt to achieve power transmission.

5. The massage chair of claim 1, wherein a front portion of the lower frame of the seat unit is pivotally connected to a footrest having a roller shell, and at least a massaging roller is accommodated inside of the roller shell to achieve the foot massage.
